(19) United States
(12) Patent Application Publication
(10) Pub. No.: US 2003/0031995 A1
(43) Pub. Date: Feb. 13, 2003

(54) Method and audiovisual system for student journal

(76) Inventor: Abbey Laura, Mentor, OH (US)

Correspondence Address: DRIGGS, LUCAS, BRUBAKER & HOGG CO., L.P.A., DEPT. DLBH, 8522 EAST AVENUE, MENTOR, OH, 44060, US

(21) Appl. No.: 10/186,524

(22) Filed: Jul. 1, 2002

Related U.S. Application Data
(60) Provisional application No. 60/301,721, filed on Jun. 29, 2001.

(51) Int. Cl. G09B 5/00

(52) U.S. Cl. 434/317

(57) ABSTRACT

The present invention relates to a method and audiovisual system for a journal. The method and system comprises written exemplary text describing a journalized activity, graphical images of items described in the written exemplary text, journalizing instructions, formatted journal entry forms configured to conform to the journalizing instructions and the written exemplary text, and an audio recording device. Additional optional components also include prerecorded audio narratives, dolls, costumes and accessories for dolls, and cameras.

### RELATED APPLICATION

This application claims the benefits of provisional application Serial No. 60/301,721, filed Jun. 29, 2001.

### FIELD OF THE INVENTION

The present invention relates to a method and audiovisual system for a multimedia journal.

### BACKGROUND OF THE INVENTION

Journalizing exercises and activities have been recognized as valuable tools in teaching reading and writing skills to primary school students. It is also well known in the education of children that boys and girls learn reading and writing, as well as learn about other concepts, in different ways. Although this may be a generalization, it is apparent that boys tend to be more visually oriented and self-centered. Accordingly, journaling exercises for boys that are more visual, or more self-centered in nature, such as stressing “what I did on my vacation” and emphasizing the drawing of pictures of themselves in the middle of activities that they took part in on their vacation, tend to be more successful in teaching boys journalizing or writing records of their activities on vacations. In contrast, the female students tend to be more verbally oriented. Accordingly, girls seem to readily take to writing written descriptions of their activities, such as vacations. Girls also are more easily encouraged to read about vacations or other educational activities, without the need for visual cues that seem to be necessary to encourage boys. Restated, boys seem more readily attracted to drawing pictures of themselves, while girls seem more readily attracted to writing written descriptions of themselves and their activities.

### SUMMARY OF THE INVENTION

The present invention relates to a method and audiovisual system for a multimedia journal. One embodiment of the present invention described herein is configured for use of a primary-school age child and, in particular, for the instruction of a child in a school or home-schooling environment for the purposes of teaching that child how to write a journal. However, it is to be understood that older children, as well as adults, may also use the present invention. Furthermore, the present invention may be used for language instruction: for example, the embodiment of the present invention described herein may be used for non-English speaking children and/or adults in a course of instruction of English as a secondary language.

### BRIEF DESCRIPTION OF THE DRAWINGS

FIG. 1 is an illustration of a picture book according to the present invention.

FIG. 2 is an illustration of a book page according to the present invention.

FIG. 3 is a set of front, side and back perspective illustrations of a doll according to the present invention.

FIG. 4 is a set of front, side and back perspective illustrations of another doll according to the present invention.

FIG. 5 is an illustration of an exemplary journal according to the present invention.

FIG. 6 is an illustration of the inside cover jacket and facing page of a journal according to the present invention.

FIG. 7 is an illustration of a journal page according to the present invention.

FIG. 8 is an illustration of a formatted journal according to the present invention.

FIG. 9 is an illustration of an inside cover jacket of a journal according to the present invention.

FIG. 10 is an illustration of opposing journal pages according to the present invention.

FIG. 11 is an illustration of another journal page according to the present invention.

FIG. 12 is a front perspective illustration of a camera for use with the present invention.

FIG. 13 is a front perspective illustration of articles of manufacture comprising a computer usable medium having a computer readable program according to the present invention.

### DETAILED DESCRIPTION OF THE INVENTION

The present invention uses both audio and visual elements in order to reinforce and take advantage of both visual and verbal cues and exercises, so that boys will be encouraged by the visual cues, and girls will be encouraged by the verbal or written cues. It is also readily apparent that, although the present invention may describe boys and girls and their learning patterns and their abilities unique based upon their sexual identity, some boys may be more verbally oriented and some girls may be more visually oriented. The present invention is appropriate for any sex or any child. What is important is that the present invention contains both verbal and visual or auditory cues and exercises, thus encouraging the student who is using this method or system and will be encouraged by either of those cues.

The method and system of the present invention comprises visual cue elements which may include picture books, pictures appearing in journaling books, and picture-taking activities. The method and system may provide for taking photographs by the student using a camera provided by the system and method, or a user may insert pictures taken and developed by the student through the student's own camera device in a journal photo album page. The method and system also uses audio cue elements, which may comprise pre-recorded music and word compositions, spoken word recordings, and voice and sound recording activities involving tape recording devices and the like. For example, a microcassette recorder may be used to play tapes supplied with the materials that have pre-recorded audio content, such as written narration by a character or characters and, optionally, music as well. The system and method also uses written cue elements, such as written text material and blank entry pages in which a student may write down his or her observations.

Also, in order to encourage the child to enjoy using the method and system, the auto-recording device is incorporated into a doll that the child carries with him or her as they complete the activities that are recorded in the journal. A preferred embodiment of the present invention is centered around a traveling journal, which is used to record activities taken by a child while on a field trip, or perhaps on a family vacation. Although the following embodiment described will be centered upon a traveling journal embodiment, it is understood that other forms of journaling activities may be used with the present invention, and the embodiment described is not intended to restrict the definition of the invention to that embodiment.

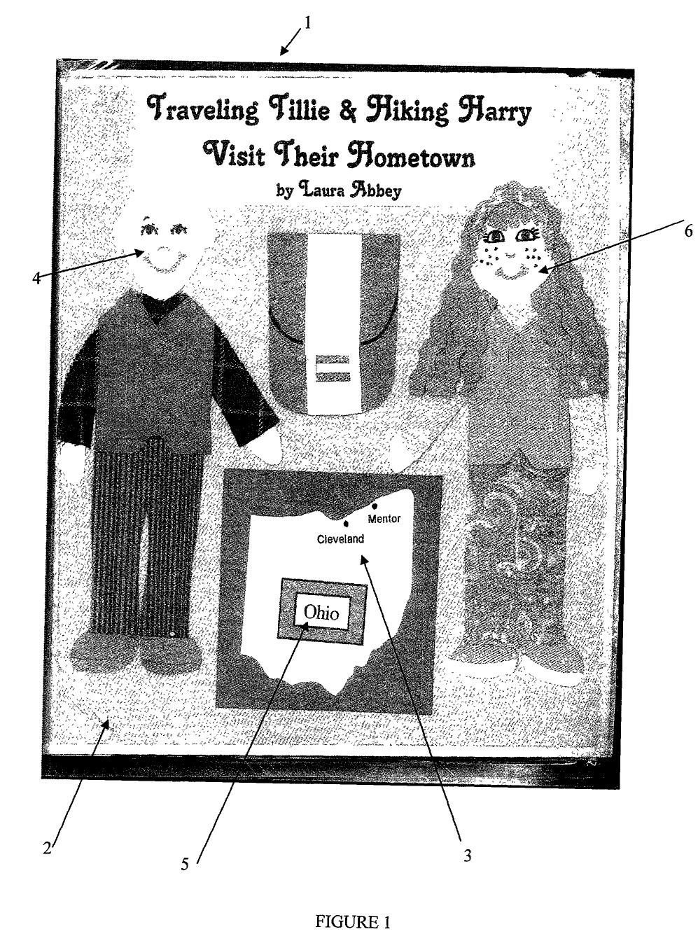

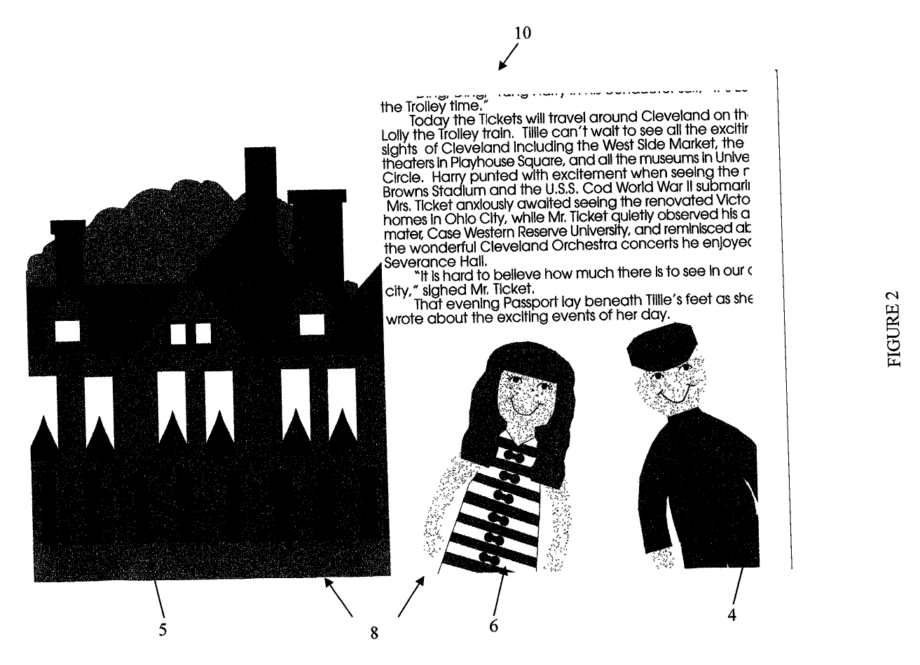

One embodiment of the present invention comprises a picture book describing an exemplary journalizing activity by one or more characters. FIG. 1 shows the cover page 2 of a picture book 1 that features two characters known as Hiking Harry™ and Traveling Tillie™. Thus, this picture book 1 may be desired for use with both male and female students, or wherever a student may prefer to relate to either a male or female character. The picture book 1 shows the graphical representations of the Hiking Harry™ character 4 and Traveling Tillie™ character 6 as they complete trips to various attractions in their local communities. Referring now to FIG. 2, page 8 of the book shows a graphical illustration of the characters 4 and 6 at locations within the local community, preferably well-known locations such as a museum or an amusement park. Written text 10 describes the activities that the characters took part in at these destinations and also what they enjoyed about these destinations, and preferably information about the destinations themselves, such as information that a teacher would want her student to provide in any journal describing field trip activities or vacation activities. It is intended that the picture book 1 serve as more or less an instructional guide to the student to show the student what the student should be doing on a field trip, and also to provide an example of how to record their activities in a journal format on such a field trip or vacation.

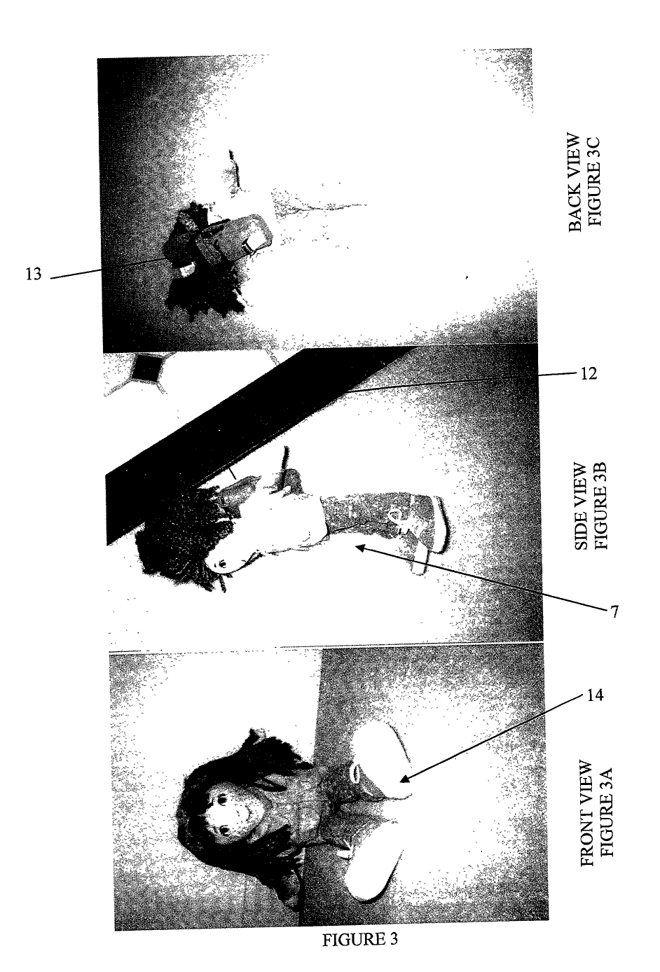

A second component of the method and system is an audio recording device. Referring now to FIG. 3, perspective views of a Traveling Tillie™ doll 7 containing an audio recording device 13 are shown. The doll 7 is preferably a soft child's doll wearing a backpack 12 within which is contained an audio microcassette recorder 13. The microcassette recorder 13 has a built-in microphone (not shown), as is typical and well-known, which can be used by a user to record sounds, dialog or spoken words. A separate remote microphone (not shown) may optionally be used, connected to said microcassette recorder and either held by the doll in her hand, or perhaps to be used and held by the child herself. It is intended that the child will carry the doll with him on the vacation or field trip and, whenever the child has an observation that he feels might be helpful, he may easily press the recording button and record that observation contemporaneously. This is important, in that the child is enabled to make their observations while they are actually taking part in the activity, rather than waiting until the child returns home and relying upon the child's memory to remember all the significant events of the day in a short period of time. It is believed that by contemporaneously recording these events, the student will make many more observations than the student might otherwise make at the end of the day.

Alternative recording devices may include computer-related devices, such as an audio recorder configured to import recordings into computer software or hardware, wherein the software or hardware device may translate audio dictation into word processing text. Examples of such systems are the Dragon Naturally Speaking® system by Lerner & Hauspie, Inc., and the ViaVoice® system by I.B.M., Inc. Similarly, digital recording technology may be used to convert analog audio dictation and sound files into digital files that may be readily transferred into a computer for dictation software applications, or transferred to a remote computer through a computer network, or the Internet. Such digital files may also be freely sent through the Internet to other parties, such as a teacher, a friend, or a relative. The preceding list is not intended to be exhaustive, and other applications will be readily apparent to one skilled in the art.

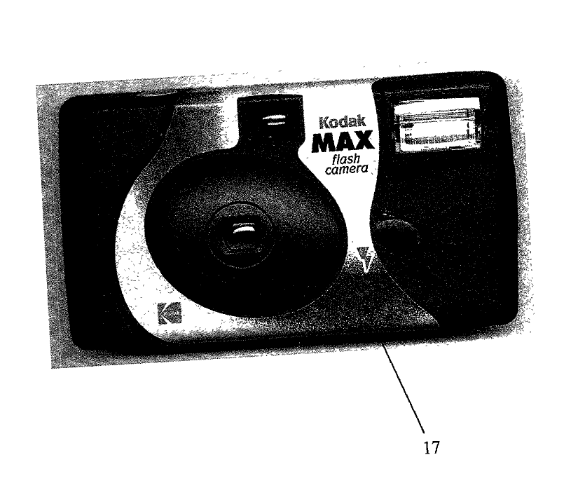

It is also preferred that the student will have a camera with him or her on this vacation or activity to take pictures of the different locations and activities in which they participated. FIG. 12 shows a typical camera 17 that may be used with the present invention. The camera 17 may be part of the present system or method, or it may be a suggested user option. The camera 17 may be a conventional film camera, or it may be a digital camera. A small camera (not shown) may also be incorporated into the dolls 7 or 9, such as a digital camera. Although it is preferred that the child take pictures, it is not necessary, and an adult or other person may take pictures of the activities. Also, postcards or other pictures may instead or additionally be purchased as souvenirs and referred to by the student as they recall their day and recall their activities into the microcassette recorder.

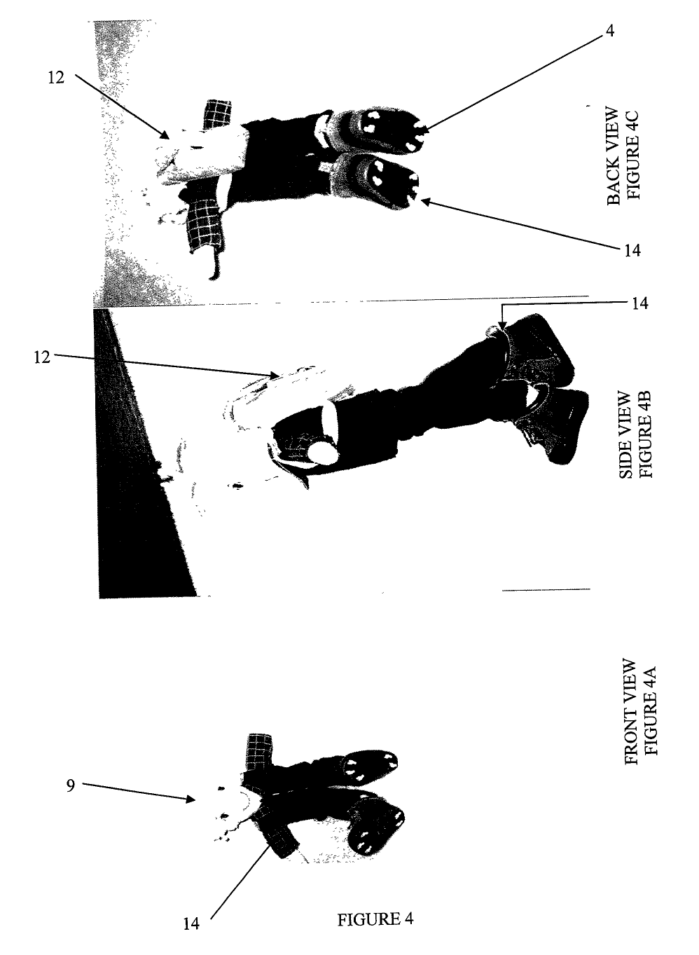

Table I lists exemplary dimensions of the Hiking Harry™ and Traveling Tillie™ dolls shown in FIG. 3 and 4. These dimensions are provided as an example of embodiments that are preferable for use by a child with this method and system. However, it is understood that other dimensions are readily usable in this method and system. Similarly, materials may be used, other than the soft materials shown in FIGS. 3 and 4, for the doll embodiments. And although the doll embodiments described in the present invention have detachable clothing 14, it is not necessary that detachable clothing 14 be utilized.

TABLE I
Hiking Harry's Measurements

| | | |
|---|---|---|
| Length of Body Including Head: | 16 | inches |
| Width of Body: | 4½ | inches |
| Circumference of Body: | 8½ | inches |
| Length of Ann: | 5½ | inches |
| Arm Span: | 13 | inches |
| Circumference of Arm: | 3 | inches |
| Length of Leg: | 8 | inches |
| Circumference of Leg: | 4½ | inches |
| Circumference of Head: | 10 | inches |
| Foot from Heal to Toe: | 3½ | inches |

Traveling Tillie's Measurements

| | | |
|---|---|---|
| Length of Body Including Head: | 15½ | inches |
| Width of Body: | 4¼ | inches |
| Circumference of Body: | 8½ | inches |
| Length of Arm: | 5 | inches |
| Arm Span: | 13½ | inches |
| Circumference of Arm: | 3 | inches |
| Length of Leg: | 7½ | inches |
| Circumference of Leg: | 5 | inches |
| Circumference of Head: | 9¼ | inches |
| Foot from Heal to Toe: | 3 | inches |

Where detachable clothing 14 is provided, said clothing may function as costumes that may be removed and replaced. This will enable the dolls to be dressed up in clothing and costumes appropriate to the activity. For example, dressing the doll in clothing appropriate to the period of the historical site may facilitate a trip to a historical site such as the home of a late president. Similarly, dressing the doll in astronauts or scientifically related costuming may facilitate a trip to a science museum. It is readily apparent that accessories may be provided by a manufacturer or seller of the dolls for use with the method or system as stand-alone accessories or latter added accessories. In this way, a child may own one doll and may later buy different outfits appropriate to each vacation or field trip that the child may take with the doll.

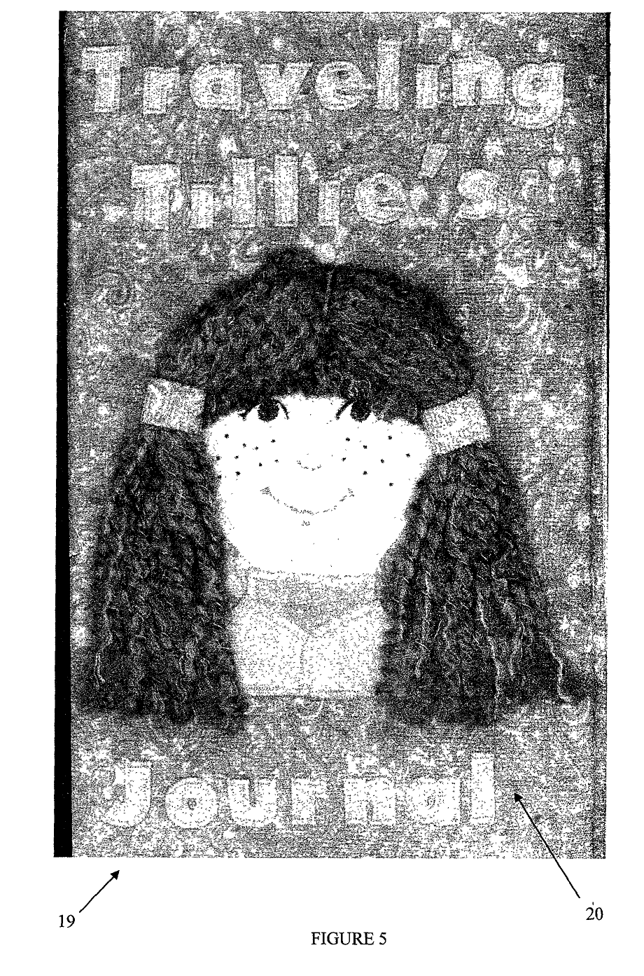

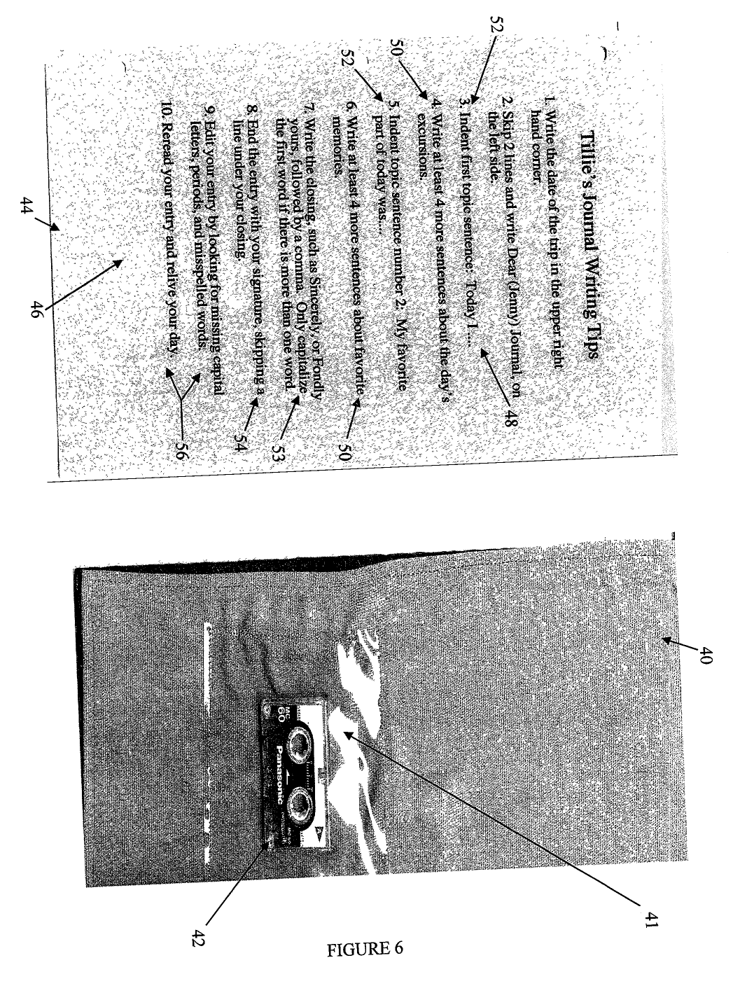

Another component of the present system and method is an exemplary journal. FIG. 5 illustrates a cover 20 to Traveling Tillie's Journal™ 19. The journal 19 contains exemplary entries that the student should emulate for their own journal entries. FIG. 6 shows an inside front jacket 40 for use with the journal 19, having a pocket 41 that holds a microcassette 42. The microcassette 42 may have a pre-recorded narrative that features the voice of the character, in this case Traveling Tillie™, describing her activities and what she did. Alternatively or additionally, the microcassette may have a recording of music or sound tracks or other sound effects correlated to the journalized activity.

Instruction page 44 of FIG. 6 shows a table of writing instructions 46 according to the present invention that may be inserted in the writing journal, for the purposes of conveying elements that a teacher may desire the student to enter into his or her journal. The instruction page 44 may be the first page appearing opposite the inside cover jacket 40, or it may appear elsewhere within the journal 19. The structure of the entry may also be provided, indicating the number of paragraphs for older children or the number of sentences or words for younger children, in order to teach proper composition structure. These tips may be tailored to a specific activity, or may be more general in imparting good journalizing habits to the student using this book. In the present embodiment, a predetermined beginning phrase 48 is provided for a first topic sentence. Indicators 50 provide the number of sentences required to describe the activity. Instructions 52 direct the student to indent initial topic sentences and start new paragraphs. A salutation instruction 53 is provided, and a signature instruction 54. Review instructions 56 direct the user to review their work, edit any mistakes and enter the corrections on the journal, and reread and “relive” their work.

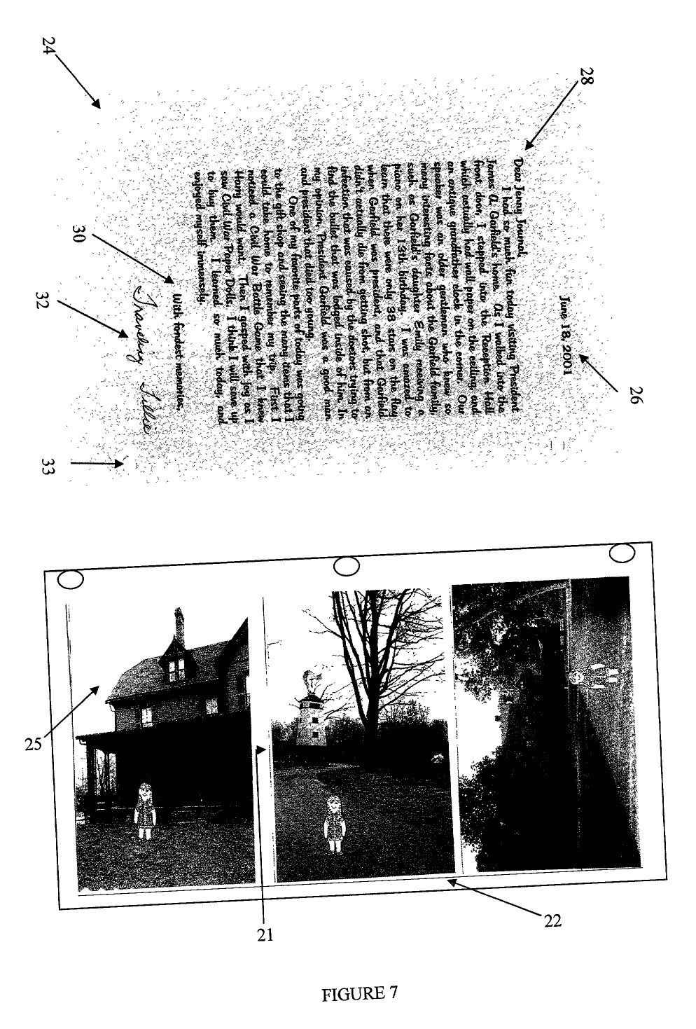

FIG. 7 shows an exemplary journal entry page 24 illustrating exemplary journal text corresponding to the writing instructions 46 of FIG. 6 and to an opposing page 25 of photographs 22. It is preferred that the activities described by the text on the exemplary journal entry page 24 relate to the photographs 22, which will preferably depict a location that the student has attended or that Travelling Tillie™ has attended. It is intended that the exemplary journal entry 24 illustrate a preferred format and content template for a user of the journal, depicting elements required by the teacher for completion of an assignment using the journal system. For example, the date 26, salutation 28, a closing comment 30 and the exemplary student's signature 32 are shown.

It is readily apparent that the present method and system may be tailored to the age of the intended user of the journal. In this way, a journal for first-grade students may have a much more simplistic format than one intended for older students. It is also readily apparent that the same journal may be used with different page inserts as the child advances in age and curriculum. One way to facilitate this is to structure the journal in a three-ring binder type of system. In this way, pages can be readily removed and inserted based upon a different child, different field trip or activity or family vacation, or perhaps later more challenging curriculum and inserts. Accordingly, it is preferred that pages designed for use with the present invention are formatted to the same size and dimensions, and with three-ring binder perforations 33.

Table II provides a written transcription of an exemplary dialogue that may be contained on a microcassette tape 42. As the transcription shows, the dialogue may be written in the vernacular of the age appropriate to the person using the journal system. For example, instructions may be written or spoken as a child might recite them, along with excited utterances and other child-specific references. In this way, the audiocassette may provide a means of reinforcing written instructions that are found in the journal and, additionally or alternatively, a lesson chosen by an instructor utilizing the system or method. It is well known in educational circles that reinforcement is an important element in teaching to both children and adults. Also, it is well known that some students may respond better to written instruction than to auditory instruction or, conversely, may respond better to auditory instruction than written instruction. In this way, the system provides reinforcement in both auditory and written instruction, thereby enabling the teacher to reach the child through the method that may work better with that particular child.

TABLE II
What Harry Says on the Tape

Hi, Hiking Harry here to tell how I write in my journal. I follow many
of the same steps as Tillie, but I am more interested in adventure,
history, and make believe than in the actual writing. Like Tilli1e, I also
begin with the date in the right hand corner, since it is important to
document when my journal becomes part of history. For my greeting,
I don't name my journal, but I write to someone different each time.
Sometimes I write to someone I met on my trip, or an animal I saw,
but my favorite is to write to someone famous, especially someone
famous from the past. Of course these people, or animals never receive
the letters, but it's great fun pretending, and makes it more exciting
for me to write.
Now for the body of my letter. I also write 2 paragraphs per journal
entry. Not only am I writing to this special person as an observer,
but as an active participant in my own written adventure, so I become
part of the story. I try to turn each trip into a reenactment with me
as one of the main characters. To refresh my mind I listen to the tape
from my day, and either act out events while listening, or draw a
picture. Then I begin dictating to my tape recorder as though I am
talking to the person to whom I am writing. I listen to my dictation
and write my first paragraph. “Oops, I almost forgot to indent my
first paragraph.”
Following paragraph one, I begin paragraph two with the conclusion of
my exciting adventure. I include phrases such as, “I wish I could . . . ,”
“From my point of view . . . , or “Next I hope to . . . ”, always
remembering to indent paragraph two before Tillie sees this. This
paragraph allows me to share my feelings about the day, again writing
in story form.
Finally, I write the closing. I like to end with “Your companion & friend,”
comma, and sign my name below.
Now I need to become the editor of this journal entry, so excuse me while
I retrieve my editing hat. A good editor must always check for spelling
errors with his or her trusty dictionary. I then read my story out loud, and
only-stop when I see a period. If it seems like I should pause while
reading, and I don't, then I know I missed a comma, period, question
marks, or exclamation point. I then look to see if my first sentence begins
with a capital letter, and it there is a capital letter before each period.
Phewww, now I can finally read my journal, and reenact my adventure.

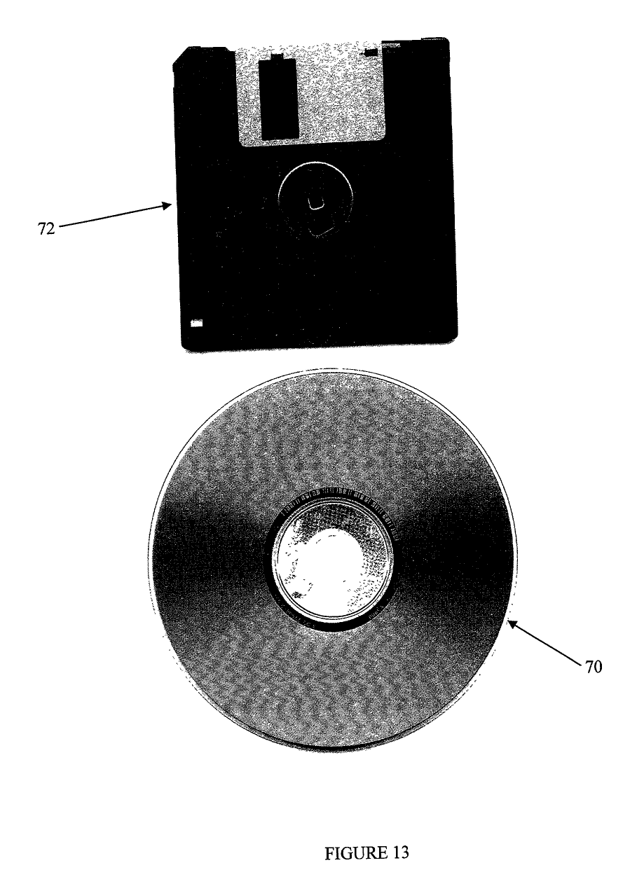

It is to be understood that the journal described thus far may also reside in a computer-based format, such as in software residing on a CD-ROM 70 or floppy disc 72 shown in FIG. 13, for use on a personal computer (not shown). A computer-based embodiment may reside on a user's personal computer; on a central network server to be accessed by more than one user, such as a teacher and her students; or it may reside on a computer or computer server accessible by the internet, for remote use by any authorized user with internet access. Such a computer based embodiment may also feature a customized printer (not shown) or other associated hardware devices.

Although all of the elements described thus far have been described in the context of being utilized with each other, it is apparent that any of the particular elements described thus far may stand alone and be used on their own. For example, the picture book 1 described above may be sold on its own as just a standard picture book. In this way, the picture book 1 may be sold through bookstores, or carried by schools or other public libraries. Similarly, the dolls 7 and 9 and recording device 13 may be sold separately. This enables the method or system to be sold in one complete form, containing all of the components. Or individual components may be purchased at different times by the students or teachers. This is important in enabling the system to be tailored to the age of the student. For example, a doll or character may be used with more than one age group in a school system, wherein the journals may be age specific. Any number of combinations is possible with the components described thus far.

Similarly, the picture book 1 may be specific to a site or geographic area.

Referring again to FIG. 1, a specific museum, city 3, county, state 5 or country may be provided. Or the picture book 1 may be specific to an age, sex, language, or other identifying criteria of the student or purchaser for which this product is intended. Also, different picture books may contain different elements. Said elements may include historical entries that, for example, a child's grandparents or parents may have written that may be unique to that individual child, or the geographic location that is described in the book. In this way, the remainder of the components of the system may be totally redefined merely by changing the picture book 1 that is used as an example for the student in illustrating how the different components of the system may be used.

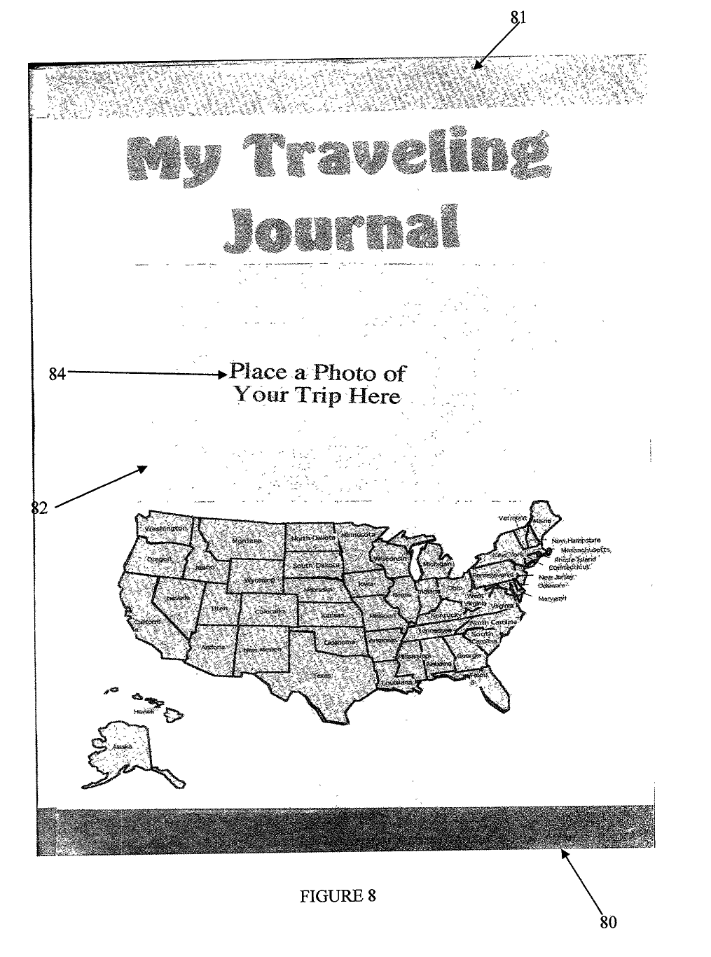

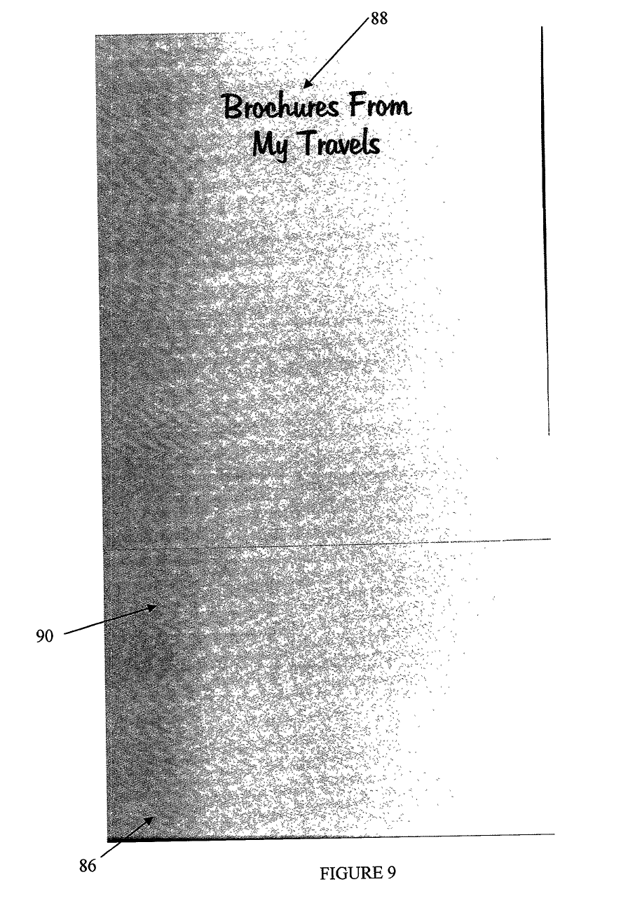

Another component of the present system and method is the working journal. Referring now to FIG. 8, a working traveling journal 80 is provided, showing a front cover 81. A cover sleeve 82 is provided for the insertion of a picture (not shown) of the student who is using this particular journal, along with an instructive label 84. FIG. 9 shows the inside jacket 86 for use with a front or back journal cover. The inside jacket 86 has a “Brochures From My Travels” heading 88 and a pocket 90 for holding any brochures relevant to the field trip or vacation described in the journal. The pockets may also be used for postcards, souvenirs, ticket stubs or other relevant indicia of the journalized activity.

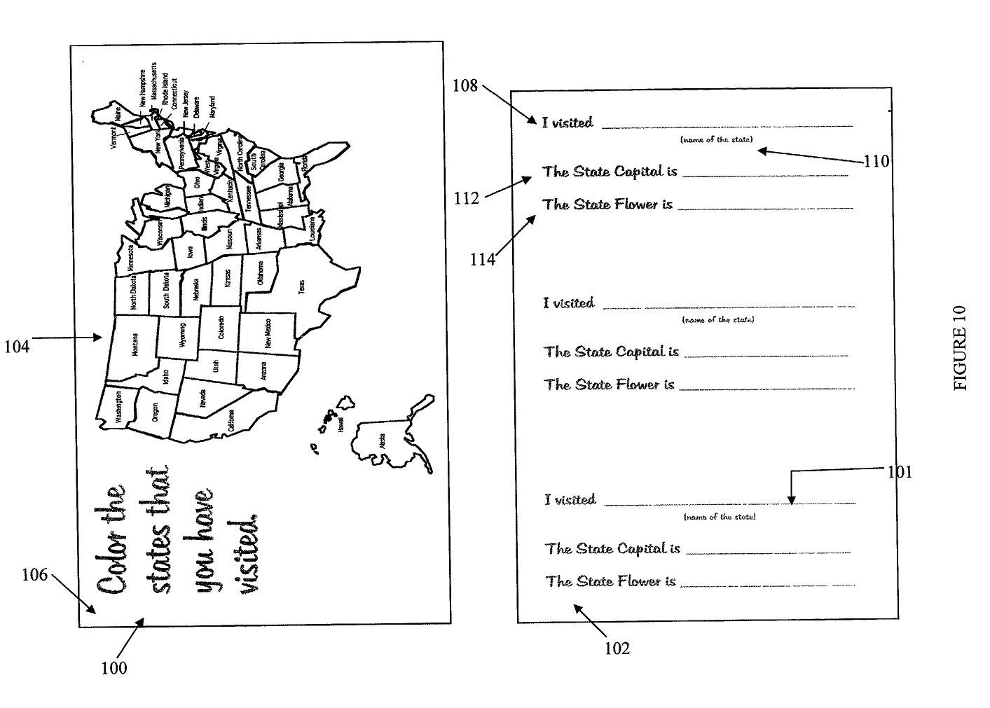

FIG. 10 illustrates opposing pages 100 and 102 within the working journal 80. Map page 100 provides a map 104 of the United States, with instruction 106 that the student color the state or states that the student visited. It is readily apparent that other countries may be inserted here for use with this journal system and method in other countries. Alternatively, a view of a state, city, or other region (such as Disney World®) may be provided, in any desired scale or degree of detail, with additional specific terms relevant to said region.

Entry page 102 provides opposing page entry blanks 100, which may be used by a student to list the name of the place or other information. The information entered may be specific to an instruction, such as a “Name this state” instruction 110. Also, the student may be required to provide additional information through complete-the-sentence instructions 112 and 114. In this way, other materials may be incorporated into this system or method and based upon the age of the student; for example, the student may be required to research external library references for the answers.

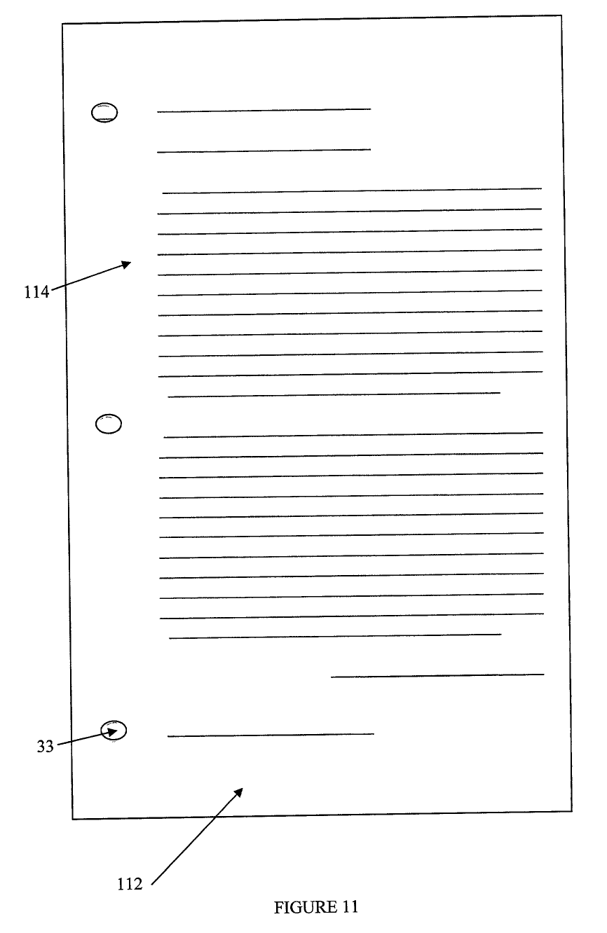

FIG. 11 shows an entry page 112, for insertion into the journal. Blank lines 114 are provided for written entries by the student. These lines may be formatted in a specific way, for example to provide designated places for date, salutation, body text, and signature areas corresponding to the writing instructions 46. The number of the pages may vary, and a three-ring binder book structure is preferred to allow a user to vary the number of pages used with the journal.

It is also preferred that at least one page 25 of empty photograph sleeves 21 be provided. It is preferred that each page 25 is arranged opposing a completed journal entry pages 112. It is intended that the student insert pictures representative of the location or activity as described in the opposing entry pages 112. Alternatively, ticket stubs, postcards, matchbook covers or other graphic items may be inserted into the sleeves 21.

The inside cover pocket 86 may also be used for holding audio recording media, such as a microcassette 42. It is intended that the student record their observations, dialogue, sounds, interviews or other material on the microcassette 42, as described above, and the microcassette 42 may then be kept with the journal. This may be desirable to enable later completion of the journal after the trip or activity has been completed. Also, the system or method may be used to record contemporaneous sounds with any kind of event or field trip. For example, a trip with a grandmother may be remembered by having the grandmother speak into the microcassette recorder. In this way, the system can also be used to archive the thoughts and sounds and voices and feelings of loved ones that a child may look back upon and enjoy once the child has reached adulthood. In this way, the system and method may be used beyond just journaling activities but may also be used for chronicling family activities and fixing such activities in a specific geographic place or date in time.

The exemplary journal 19, picture book 1 and working journal 80 may be separate books, or they may be combined into one or more composite books.

Similarly, the pages described above may be inserted into any or all of the exemplary journal 19, picture book 1 and working journal 80, according to the present invention.

Accordingly, a preferred embodiment of the present invention has been described. With the foregoing description in mind, however, it is understood that this description is made only by way of example, that the invention is not limited to the particular embodiments described herein, and that various rearrangements, modifications, and substitutions may be implemented without departing from the true spirit of the invention as hereinafter claimed. It is also to be understood that, unless otherwise indicated, gender references are not specific and the feminine form has generally been chosen for expediency to indicate a generic user, and gender-specific pronouns may generally be interchanged (i.e., “him” for “her” and the converse).

What is claimed is:

1. A method for journalizing, comprising the steps of:
providing a written exemplary text describing a journalized activity;
providing graphical images of items described in the written exemplary text;
providing journalizing instructions;
providing formatted journal entry forms configured to conform to the journalizing instructions and the written exemplary text;
providing an audio recording device;
engaging in an activity;
using the audio recording device to record oral observations of the activity;
providing an audio playback device;
using the audio playback device to playback the recorded oral observations; and
journalizing a written description of the activity by populating the formatted journal entry forms with written observations responsive to the written exemplary text, the graphical images and the recorded oral observations.

2. The method of claim 1, further comprising the steps of:
providing a prerecorded audio narrative;
playing the prerecorded audio narrative; and
wherein the step of journalizing is further responsive to the playback of the prerecorded audio narrative.

3. The method of claim 2, further comprising the steps of:
providing a character doll; and
incorporating the character doll into at least one of the written exemplary text, the graphical images and the prerecorded audio narrative;

4. The method of claim 3, further comprising the steps of:
providing at least one removable costume accessory for the doll correlating to at least one of the written exemplary text, the graphical images and the prerecorded audio narrative; and
attaching the audio recording device to the doll by removably inserting the device into the at least one removable costume accessory.

5. The method of claim 4, further comprising the step of obtaining visual images corresponding to the activity, wherein the step of journalizing is further responsive to the obtained visual images.

6. The method of claim 5 wherein the character doll is a female child character or a male child character.

7. The method of claim 6 wherein the step of providing the prerecorded audio narrative further comprises the step of providing at least a portion of the narrative as a spoken oral performance by the character doll.

8. A multimedia journal, comprising:
a written exemplary text describing a journalized activity;
printed graphical images of items described in the written exemplary text;
journalizing instructions;
formatted journal entry forms configured to conform to the journalizing instructions and the written exemplary text;
an audio recording device; and
an audio playback device.

9. The multimedia journal of claim 8, further comprising a prerecorded audio narrative configured to be played on the audio playback device.

10. The multimedia journal of claim 9, further comprising a character doll, wherein the character doll is incorporated into at least one of the written exemplary text, the graphical images and the prerecorded audio narrative;

11. The multimedia journal of claim 10 further comprising at least one removable costume accessory for the doll correlating to at least one of the written exemplary text, the graphical images and the prerecorded audio narrative, wherein the audio recording device is attached to the doll by removably inserting the device into the at least one removable costume accessory.

12. The multimedia journal of claim 11 further comprising at least one repository for receiving visual images.

13. The multimedia journal of claim 12 further comprising at least one repository for receiving and displaying visual images.

14. The multimedia journal of claim 13 further comprising a visual recording device and wherein the at least one repository is configured for receiving images produced by the visual recording device.

15. The multimedia journal of claim 14 wherein the character doll is a female child character or a male child character.

16. The multimedia journal of claim 15 wherein the prerecorded audio narrative further comprises a spoken oral performance by the character doll.

17. An article of manufacture comprising a computer usable medium having a computer readable program embodied in said medium, wherein the computer readable program when executed on a computer causes the computer to:
display a written exemplary text describing a journalized activity;
display graphical images of items correlated to the written exemplary text;
display journalizing instructions; and
provide at least one formatted journal entry form configured to conform to the journalizing instructions and the written exemplary text, and further configured to be populated with journal entries.
